(19) United States
(12) Patent Application Publication
(10) Pub. No.: US 2008/0094317 A1
(43) Pub. Date: Apr. 24, 2008

(54) PLASMA DISPLAY PANEL

(75) Inventor: Dong-Hyun Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/782,905

(22) Filed: Jul. 25, 2007

(30) Foreign Application Priority Data
Oct. 18, 2006 (KR) 10-2006-0101349
Dec. 12, 2006 (KR) 10-2006-0126253

(51) Int. Cl. G09G 3/28

(52) U.S. Cl. 345/65

(57) ABSTRACT

A plasma display panel including first and second substrates facing each other and spaced apart from each other, barrier ribs disposed between the first and second substrates and defining discharge cells, phosphor layers formed in the discharge cells, address electrodes arranged on the first substrate and extending in a first direction, first and second electrodes formed on the second substrate and extending in a second direction crossing the first direction, and a dielectric layer covering the first and second electrodes. Each of the first and second electrodes includes at least one bus line formed of a nontransparent material to extend in the second direction on the second substrate, and the dielectric layer is provided with grooves formed at portions adjacent to the bus lines so as to increase the intensity of the visible light generated by the gas discharge in the discharge cells.

### CROSS-REFERENCE TO RELATED APPLICATIONS

This application claims the benefit of Korean Patent Application Nos. 2006-101349 and 2006-126253, filed Oct. 18, 2006 and Dec. 12, 2006 respectively, in the Korean Intellectual Property Office, the disclosures of which are incorporated herein by reference.

### BACKGROUND OF THE INVENTION

1. Field of the Invention

Aspects of the present invention relate to a plasma display panel and, more particularly, to a plasma display panel that can enhance uniformity a light emission from discharge cells even when electrodes are formed with nontransparent bus lines.

2. Description of the Related Art

Generally, a plasma display panel (PDP) is a display device that displays an image using red, green and blue visible light created by exciting phosphors using vacuum ultraviolet (VUV) or far ultraviolet (FUV) rays having wavelengths about 10 to 200 nm emitted from plasma generated by a gas discharge.

For example, in an alternating current (AC) plasma display panel, address electrodes are formed on a rear substrate. The address electrodes are covered by a first dielectric layer. Barrier ribs are arranged in a stripe pattern on the dielectric layer between the address electrodes. Red, green and blue phosphor layers are formed on the barrier ribs and the dielectric layer. A plurality of display electrodes, each having a pair of sustain and scan electrodes, are arranged on a surface of the front substrate between the front substrate and the rear substrate. The display electrodes extend in a direction crossing the address electrodes. The display electrodes are covered by a second dielectric layer and an MgO protective layer. Discharge cells are formed at regions where the address electrodes formed on the rear substrate cross the sustain and scan electrodes formed on the front substrate. Typically, millions of the discharge cells are arranged in a matrix pattern in the plasma display panel.

Each of the sustain and scan electrodes includes a transparent electrode and a nontransparent bus electrode. The bus electrodes are provided on peripheries of the discharge cells and the transparent electrodes are provided on central portions of the discharge cells.

Each of the sustain and scan electrodes includes the transparent electrode and the bus electrode. As both the transparent and the bus electrodes are formed through different processes, the number of processes, and concomitant manufacturing costs, increase.

To overcome this drawback, there has been proposed a configuration in which the transparent electrodes are removed and the sustain and scan electrodes are formed with the nontransparent bus electrodes. Additionally, in order to minimize the blocking of the visible light, each of the sustain and scan electrodes may have a plurality of bus lines formed of metal.

For example, each of the sustain and scan electrodes may have three bus lines. The light emitted from the discharge cell is blocked by a bus line formed at a central portion of the sustain electrodes, and thus the luminance is lowered at both sides of the bus line. In addition, the light emitted from the discharge cell is blocked by a bus line formed at a central portion of the scan electrodes, and thus the luminance is lowered at both sides of the bus line.

Therefore, the sustain and scan electrodes each having a plurality of bus lines deteriorates the light emission uniformity of the discharge cells.

### SUMMARY OF THE INVENTION

Aspects of the present invention provide a plasma display panel that can enhance a light emission uniformity of discharge cells, even when electrodes are formed with nontransparent bus lines.

According to aspects of the present invention, a plasma display panel includes first and second substrates facing each other and spaced apart from each other, barrier ribs disposed between the first and second substrates to define discharge cells, phosphor layers formed in the discharge cells, address electrodes arranged on the first substrate to extend in a first direction, first and second electrodes formed on the second substrate to extend in a second direction to cross the first direction, and a dielectric layer covering the first and second electrodes. Each of the first and second electrodes includes one or more bus lines formed of a nontransparent material to extend in the second direction on the second substrate, and the dielectric layer is provided with grooves formed at portions adjacent to the bus lines of each of the first and second electrodes.

The bus lines may be spaced apart from each other in the first direction. The grooves may be formed at both sides of one of the bus lines, which are located at a central portion of each of the first and second electrodes. The grooves may extend in the second direction.

The bus lines of each of the first and second electrodes may include a first bus line arranged at a side end portion of the discharge cell and a second bus line arranged in parallel with the first bus line at a central portion of the discharge cell. The second bus line may be spaced apart from the first bus line in the first direction. The bus lines may further include a third bus line disposed between the first and second bus lines, the first, second and third bus lines being spaced apart from each other in the first direction.

Each of the first and second electrodes may include a short bar to connect the first, second, and third bus lines in the first direction at the central portion of the discharge cell. The short bar may have a width defined in the second direction, the width of the short bar being less than a width of each of the first, second and third bus lines.

The grooves may be formed at both sides of the third bus line. And, one or more of the third bus lines may be provided.

The barrier ribs may include first barrier members extending in the first direction and second barrier members extending in the second direction. Conductive black stripes may be formed on an inner surface of the front substrate to correspond in location to the second barrier members. The bus line may be formed of a material including at least one of silver (Ag), platinum (Pt), palladium (Pd), Nickel (Ni), and copper (Cu).

According to aspects of the present invention, a plasma display panel includes first and second substrates facing each other and spaced apart from each other, barrier ribs disposed between the first and second substrates to define discharge cells, phosphor layers formed in the discharge cells, address electrodes arranged on the first substrate to extend in a first direction, first and second electrodes formed on the second substrate to extend in a second direction to cross the first direction, and a dielectric layer covering the first and second electrodes, the dielectric layer having a first thickness. Each of the first and second electrodes may include one or more bus lines formed of a nontransparent material and extending in the second direction on the second substrate. The dielectric layer may have a thick layer portion having the first thickness and a thin layer portion having a second thickness less than the first thickness, and the thin layer portion may be formed to correspond to the bus line.

The thin layer portion may be formed at a portion corresponding to one of the bus lines, which is located at a central portion of each of the first and second electrodes. The thin layer portion may extend in the second direction. The thin layer portion may have a width defined in the first direction and the bus line may have a width defined in the first direction. At this point, the width of the thin layer portion may be greater than the width of the bus line. The thin layer portion may be formed at a portion facing the third bus line. One or more of the third bus lines may be provided.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display panel according to aspects of the present invention;

FIG. 2 is a sectional view taken along line II-II of FIG. 1;

FIG. 3 is a top plane view of an arrangement of discharge cells, electrodes, and a dielectric layer of the plasma display panel of FIG. 1;

FIG. 4 is a perspective view of a portion IV of FIG. 3;

FIG. 5 is a schematic exploded perspective view of a plasma display panel according to aspects of the present invention;

FIG. 6 is a sectional view taken along line VI-VI of FIG. 5;

FIG. 7 is a top plane view of an arrangement of discharge cells, electrodes, and a dielectric layer of the plasma display panel of FIG. 5; and

FIG. 8 is a perspective view of a portion VIII of FIG. 7.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The example embodiments are described below in order to explain the present invention by referring to the figures. Aspects of the present invention may, however, be embodied in different forms and should not be construed as limited to the embodiments set forth herein. When it is mentioned that a layer or an electrode is said to be “disposed on” or “formed on” another layer or a substrate, the phrases mean that the layer or electrode may be directly formed on the other layer or substrate, or that a third layer may be disposed therebetween. In addition, the thickness of layers and regions may be exaggerated for clarity.

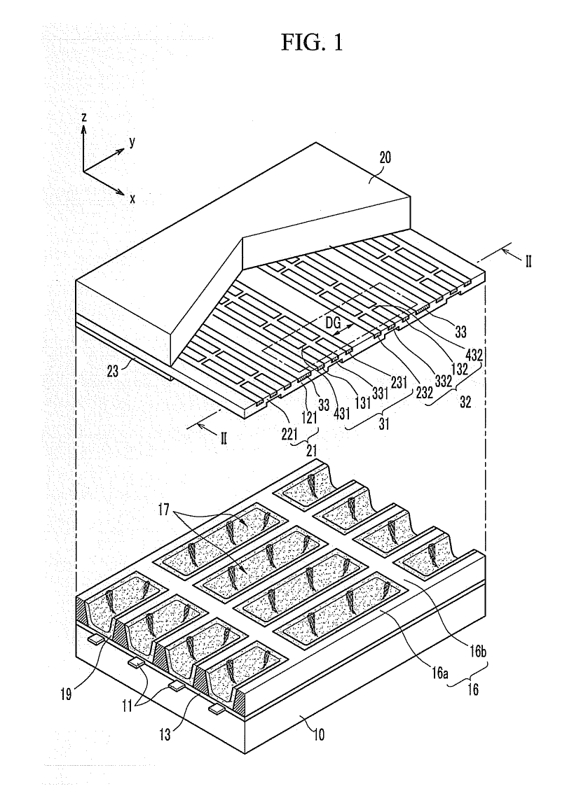

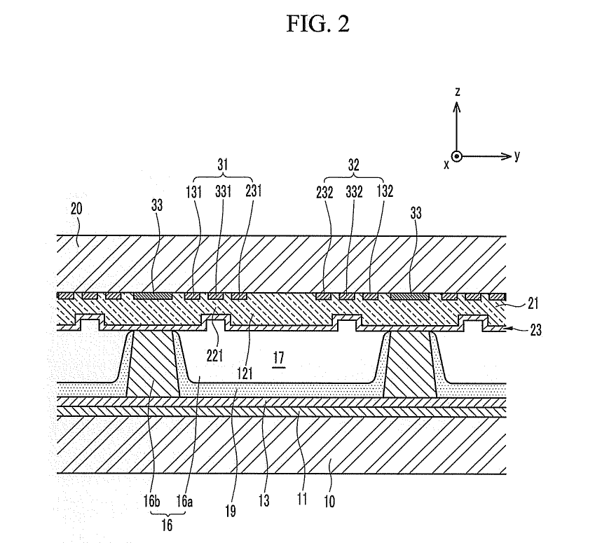

FIG. 1 is an exploded perspective view of a plasma display panel according to aspects of the present invention, and FIG. 2 is a sectional view taken along line II-II of FIG. 1.

Referring to FIGS. 1 and 2, a plasma display panel includes first and second substrates (hereinafter, “rear and front substrates”) 10 and 20 facing each other at a predetermined interval and sealed together, and barrier ribs 16 disposed between the rear and front substrates 10 and 20. The barrier ribs 16 are formed to a predetermined height between the rear and front substrates 10 and 20 to define a plurality of discharge cells 17. The discharge cells 17 are filled with a discharge gas (e.g., a mixture of gases including neon (Ne) and xenon (Xe)) to create vacuum ultraviolet rays via a gas discharge. The discharge cells 17 have phosphor layers 19 for absorbing the vacuum ultraviolet rays and emitting visible light.

In order to display an image using the gas discharge, the plasma display panel includes address electrodes 11, first electrodes (hereinafter, “sustain electrodes”) 31, and second electrodes (hereinafter, “scan electrodes”) 32. The address, sustain and scan electrodes 11, 31 and 32 are arranged between the rear and front substrates 10 and 20 at areas corresponding to the discharge cells 17.

For example, the address electrodes 11 extend in a first direction (the y-axis in FIG. 1) on an inner surface of the rear substrate 10 to continuously correspond to the discharge cells 17 that are adjacent to each other along the first direction. In addition, the address electrodes 11 are arranged in parallel corresponding to the locations of the discharge cells 17 that are adjacent to each other in a second direction (the x-axis in FIG. 1) crossing the y-axis. As such, the address electrodes 11 extend in the first direction parallel to and disposed between barrier members 16a of the barrier ribs 16 that extend in the first direction such that the address electrodes 11 correspond to the discharge cells 17 aligned in the first direction.

The address electrodes 11 are covered by a first dielectric layer 13 deposited on an inner surface of the rear substrate 10 such that the first dielectric layer 13 is disposed between the rear substrate 10 and the front substrate 20. The dielectric layer 13 prevents the address electrodes 11 from being damaged by preventing positive ions or electrons from directly colliding with the address electrodes 11. Further, the dielectric layer 13 generates and accumulates wall charges to increase the intensity of the visible light generated by the gas discharge in the discharge cells 17. Since the address electrodes 11 are arranged on the rear substrate 10 and do not interfere with the irradiation of the visible light toward the front substrate 20, the address electrodes 11 may be formed of a nontransparent material. For example, the address electrodes 11 may be formed of metal such as silver (Ag) that is excellent in conducting electricity.

The barrier ribs 16 are provided on the first dielectric layer 13 and define the discharge cells 17 as described above. As an example and as illustrated in FIG. 1, the barrier ribs 16 include first barrier members 16a extending along the y-axis and second barrier members 16b extending along the x-axis between the first barrier members 16a. The first and second barrier members 16a and 16b form the discharge cells 17 in a matrix structure.

Alternatively, the barrier ribs 16 may include first barrier members extending along the y-axis and spaced apart from each other along the x-axis. In such case, the first barrier members 16a form the discharge cells 17 in a stripe structure or pattern. That is, the discharge cells 17 may be formed to be open or continuous along the y-axis. Further, the barrier ribs 16 may be arranged to form discharge cells 17 of different shapes, such as chevron-shape, circular, or polygonal, and of different arrangements, such as positioning three discharge cells 17 in a triangular arrangement.

In FIGS. 1 and 2, the barrier ribs 16 are illustrated as defining the discharge cells 17 in the matrix structure as an example. To realize the stripe pattern of the discharge cells from this matrix structure, the second barrier members 16b are removed. As such, to align the address electrodes 11 to correspond to the discharge cells 17 as described above, the address electrodes 11 extend parallel to and are disposed between the first barrier members 16a of the barrier ribs 16. Drawings illustrating the discharge cells formed in the stripe structure, as well as different shapes and arrangements, will be omitted herein.

The phosphor layer 19 formed in each discharge cell 17 is formed by depositing fluorescent paste on a sidewall of the barrier ribs 16 and a surface of the first dielectric layer 13 between the barrier ribs 16, and then by drying and firing the deposited fluorescent paste. The phosphor layers 19 formed in the discharge cells 17 arranged along the y-axis may be formed of phosphors of an identical color. In addition, the phosphor layers 19 formed in the discharge cells 17, arranged along the x-axis, may formed of a repeating pattern of red R, green G, and blue B phosphors. However, the arrangement of the red R, green G, and blue B phosphors is not limited thereto such that any arrangement of the red R, green G, and blue B phosphors that may be used to form an image is available.

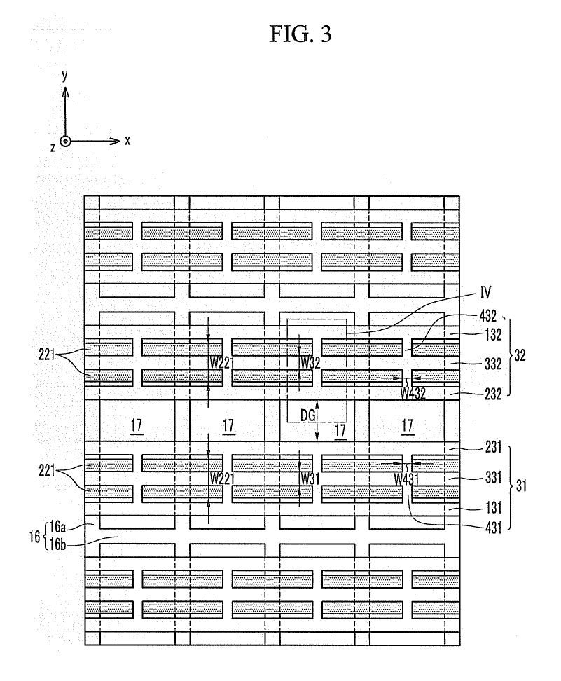

Meanwhile, the sustain and scan electrodes 31 and 32 are provided on an inner surface of the front substrate 20 to form surface discharge structures corresponding to the respective discharge cells 17, which induce the gas discharge in the discharge cells 17. The sustain and scan electrodes 31 and 32 are disposed on the inner surface of the front substrate 20 such that the sustain and scan electrodes 31 and 32 are disposed between the front substrate 20 and the rear substrate 10. As illustrated in FIG. 3, the sustain and scan electrodes 31 and 32 extend along the x-axis to cross the address electrodes 11.

Referring again to FIGS. 1 and 2, the sustain and scan electrodes 31 and 32 are arranged corresponding to the discharge cells 17 in a state of crossing the address electrodes 11. Further, as the address electrodes 11 are parallel to and disposed between the first barrier members 16a, the sustain and scan electrodes 31 and 32 extend in a direction to cross the address electrodes 11 and extend parallel to and are disposed between the second barrier members 16b of the barrier ribs 16. The sustain and scan electrodes 31 and 32 face each other while being covered by a second dielectric layer 21. The second dielectric layer 21 protects the sustain and scan electrodes 31 and 32 from the gas discharge and forms and accumulates wall charges.

The second dielectric layer 21 is covered by a protective layer 23. The protective layer 23 may function, for example, to protect the second dielectric layer 21 and increase emission of secondary electrons.

When the plasma display panel is driven to display a static or dynamic image, a reset discharge occurs by a reset pulse applied to the scan electrodes 32 during a reset period. During an addressing period following the reset period, an address discharge occurs by a scan pulse applied to the scan electrodes 32 and an address pulse applied to the address electrodes 11. Next, during a sustain period, a sustain discharge occurs by a sustain pulse that is alternately applied to the sustain and scan electrodes 31 and 32.

The plasma display panel selects discharge cells 17 that will be turned on by the address discharge occurring by the interaction between the address and scan electrodes 11 and 32, and drives the selected discharge cells 17 using the sustain discharge occurring by the interaction between the sustain and scan electrodes 31 and 32, to thereby display an image. The sustain and scan electrodes 31 and 32 function as electrodes for applying the sustain pulse required for the sustain discharge. The scan electrodes 32 function as electrodes for applying the reset and scan pulses. The address electrodes 11 function as electrodes for applying the address pulse. The sustain, scan and address electrodes 31, 32, and 11 may vary their functions depending on voltage waveforms respectively applied thereto. Therefore, the functions are not limited to those described above.

Meanwhile, each of the sustain and scan electrodes 31 and 32 is formed with a plurality of bus lines. In this case, the deterioration of the luminance at both sides of the bus line can be prevented even when the visible light is blocked by the bus lines that form each of the sustain and scan electrodes 31 and 32. Therefore, the plasma display panel has an improved light emission uniformity even with the arrangement of the bus lines that form the sustain and scan electrodes 31 and 32.

The bus lines of the sustain and scan electrodes 31 and 32 are arranged on an inner surface of the front substrate 20 and extend along the x-axis. The bus lines are formed of nontransparent metal that excellently conducts electricity. For example, the sustain and scan electrodes 31 and 32 may be formed of metal such as silver (Ag), platinum (Pt), palladium (Pd), nickel (Ni), copper (Cu), or mixtures thereof.

In addition, conductive black stripes 33 are formed on an inner surface of the front substrate 20. The conductive black stripes 33 are formed to face or to correspond to the second barrier members 16b to thereby absorb external light and improve a bright room contrast of the PDP. The conductive black stripes 33 are formed of the same material as the sustain and scan electrodes 31 and 32, which comprise the bus lines. Therefore, the conducive black stripes 33 can be formed during the same process as the sustain and scan electrodes 31 and 32 to decrease cost.

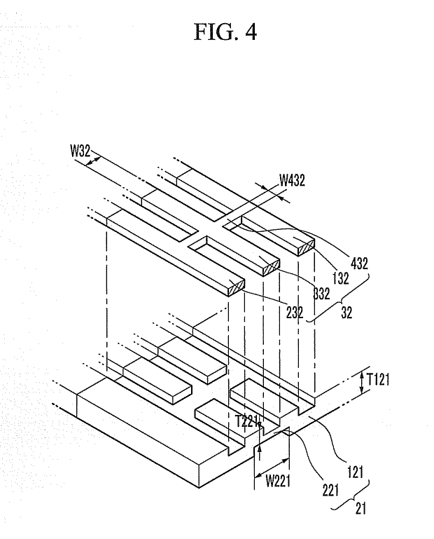

Referring to FIGS. 3 and 4, the number of the bus lines of each of the sustain and scan electrodes 31 and 32 may be two or more. In this embodiment, three bus lines spaced apart from each other along the y-axis are illustrated as an example. The sustain electrodes 31 each include a first bus line 131 and a second bus line 231. The scan electrodes 32 each include a first bus line 132 and a second bus line 232. The first bus lines 131 and 132 are arranged at both end portions of the discharge cell 17 meaning that the first bus lines 131 and 132 extend parallel to and are disposed near the second barrier members 16b of the barrier ribs 16. The second bus lines 231 and 232 extend parallel with the first bus lines 131 and 132 and are spaced apart from the first bus lines 131 and 132 along the y-axis to be located at a central portion of the discharge cell 17. Thus, the first bus lines 131 and 132 are disposed near the second barrier members 16b with the second bus lines 231 and 232 disposed therebetween, and the second bus lines 231 of the sustain electrodes 31 are disposed near the second bus lines 232 of the scan electrodes 32. A discharge gap DG is formed at each central portion of each discharge cell 17 between the second bus lines 231 of the sustain electrodes 31 and the second bus lines 232 of the scan electrodes 32.

In addition, the sustain electrodes 31 and the scan electrodes 32 may further include third bus lines 331 and 332, respectively. As illustrated in FIG. 3, each of the sustain electrodes 31 includes the first bus line 131, the second bus line 231, and the third bus line 331 in which the third bus line 331 is disposed between the first and second bus lines 131 and 231. Also, the each of the scan electrodes 32 includes the first bus line 132, the second bus line 232, and the third bus line 332 in which the third bus line 332 is disposed between the first and second bus lines 132 and 232. The third bus lines 331 and 332 are disposed between the first bus lines 131 and 132 and the second bus lines 231 and 232 and spaced apart from each other along the y-axis. However, a plurality of each of the first, second, and third bus lines may be provided in a manner parallel with each other and spaced apart from each other along the y-axis.

As described above, the sustain electrodes 31, having the first, second, and third bus lines 131, 231, and 331, and the scan electrodes 32, having the first, second, and third bus lines 132, 232, and 332, are surface-discharged in the discharge cell 17, thereby emitting the visible light necessary to form a static or dynamic image.

Most of the visible light is emitted towards the front through the front substrate 20. However, some of the visible light is blocked at both end portions of the discharge cell 17 by the first, second, and third bus lines 131, 132, 231, 232, 331, and 332 of the sustain and scan electrodes 31 and 32, respectively, such that the blocked visible light is unable to be used to display the image.

Further, the sustain and scan electrodes 31 and 32 include short bars 431 and 432, respectively. The short bars 431 and 432 connect the first bus lines 131 and 132, the second bus lines 231 and 232, and the third bus lines 331 and 332, respectively, in a direction of the y-axis at the central portion, with reference to the x-axis, of the discharge cell 17. As such, the short bars 431 and 432 are disposed between the first, second, and third bus lines 131, 132, 231, 232, 331, and 332, respectively, parallel to and equidistant between the first barrier members 16a. However, the short bars 431 connect the bus lines of the sustain electrodes 31 and are disposed nearer to one of the ends of the discharge cells 17; and, the short bars 432 connect the bus lines of the scan electrodes 32 and are dispose nearer the other of the ends of the discharge cells 17.

The short bars 431 electrically connect the first, second, and third bus lines 131, 231 and 331 within one of the sustain electrodes 31 to each other so that the first, second, and third bus lines 131, 231, and 331 of individual sustain electrodes 31 can mutually apply a same voltage, and so that the discharge in the discharge cell 17 can be diffused. In order to realize application of the voltage and generation of the surface discharge, each of the first, second, and third bus lines 131, 231, and 331 has a predetermined width W31 defined in the direction of the y-axis. Similarly, the short bars 432 electrically connect the first, second, and third bus lines 132, 232 and 332 within one of the scan electrodes 32 to each other so that the first, second, and third bus lines 132, 232, and 332 of individual scan electrodes 32 can mutually apply a same voltage, and so that the discharge in the discharge cell 17 can be diffused. And further, each of the first, second, and third bus lines 132, 232, and 332 has a predetermined width W32 defined in the direction of the y-axis; however, the predetermined widths W31 and W32 need not be equal but may be different to account for differences in the geometry of the discharge cells 17.

The short bars 431 have a width W431 defined in the direction of the x-axis. Since the short bars 431 extend along the y-axis at the central portions of the discharge cell 17, the width W431 of the short bars 431 is less than the width W31 of the bus line so as to minimize the blocking of the visible light. Similarly again, the short bars 432 have a width W432 defined in the direction of the x-axis. As the short bars 432 extend along the y-axis at the central portions of the discharge cells 17 as well, the width W432 of the short bars 432 is less than the width W32 of the bus lines so as to further minimize the blocking of the visible light. However, the widths W431 and W432 need not be equal so as to account for differences in the geometry of the discharge cells 17.

Although the above description corresponds to parallel first, second, and third bus lines 131, 132, 231, 232, 331, and 332 with crossing parallel short bars 431 and 432, aspects of the current invention are not limited thereto. For example, the sustain and scan electrodes 31 and 32 may be formed to correspond to discharge cells 17 formed having a different shape than herein described. Further, the short bars 431 and 432 may be angled such that each short bar 431 and 432 forms a chevron-shape. Also, the short bars 431 and 432 may be split into sub-short bars and aligned such that the sub-short bars connecting the first bus lines 131 and 132 and the third bus lines 331 and 332 do not align with the sub-short bars connecting the second bus lines 231 and 232 and the third bus lines 331 and 332 of the sustain and scan electrodes 31 and 32, respectively.

Further, the above description only describes the sustain and scan electrodes 31 and 32 as comprising the first, second, and third bus lines 131, 132, 231, 232, 331, and 332, respectively; however, the sustain and scan electrodes 31 and 32 are not limited thereto. For example, each of the sustain and scan electrodes 31 and 32 may include only first bus lines 131 and 132, and the dielectric could include grooves or thin layer portions corresponding to or formed about the first bus lines 131 and 132 as will be described below.

The sustain and scan electrodes 31 and 32 that are structured as described above are covered by a second dielectric layer 21 formed on the inner surface of the front substrate 20 and a protective layer 23 formed on the surface of the second dielectric layer.

A second dielectric layer 210 includes thick layer portions 121 and thin layer portions 221, as illustrated in FIGS. 1 through 4, that are formed according to the arrangement of the first, second, and third bus lines 131, 231 and 331 of the sustain electrodes 31 and the first, second, and third bus lines 132, 232 and 332 of the scan electrodes 32. A protective layer 23 is formed on both the thick and thin layer portions 121 and 221 so as to protect the thick and thin layer portions 121 and 221 of the second dielectric layer 210 from the discharge within each discharge cell 17.

With specific reference to FIG. 4, the thick layer portions 121 have a first thickness T121. The thin layer portions 221 are formed in at least one of the portions corresponding to the first, second, and third bus lines 131, 231, and 331 of the sustain electrodes 31 and the first, second, and third bus lines 132, 232 and 332 of the scan electrodes 32. The thin layer portions 221 have a second thickness T221 that is less than the first thickness T121, thereby having a higher light transmittance than that of the thick layer portions 121. In addition, the thin layer portions 221 increase the capacitance generated between the sustain and scan electrodes 31 and 32, and thus increase an amount of the wall charges that are generated and accumulated during the discharge, thereby increasing the intensity of the visible light.

The thin layer portions 221 may be formed at portions corresponding to the third bus lines 331 and 332, resulting in the arrangement of the thin layer portions 221 at central portions of the sustain and scan electrodes 31 and 32. The thin layer portions 221 may correspond to the third bus lines 331 and 332 and extend along the x-axis. The thin layer portions 221 are provided in the form of grooves adjacent to the first, second, and third bus lines 131, 132, 231, 232, 331, and 332. The thin layer portions 221 may extend an entire length of the x-axis, or the thin layer portions 221 may be interrupted and separated by additional thick layer portions 121 (not shown).

Two (first and second) thin layer portions 221 are provided per one discharge cell 17. That is, in one discharge cell 17, the first thin layer portions 221 are formed to correspond to the third bus lines 331 of the sustain electrodes 31 and the second thin layer portions 221 are formed to correspond to the second bus lines 332 of the scan electrodes 32.

The first thin layer portion 221 has a width W221 defined in a direction of the y-axis. The width W221 of the first thin layer portions 221 may be greater than the width W31 of the first, second and third bus lines 131, 231, and 331 of the sustain electrodes 31. The second thin layer portion 221 has a width W221 defined in a direction of the y-axis. The width W221 of the second thin layer portions 221 may also be greater than the width W32 of the first, second, and third bus lines 132, 232 and 332 of the scan electrodes 32.

The first and second thin layer portions 221 increase the transmittance of the visible light within the range of the widths W221 of the first and second thin layer portions and compensates for the luminance that is lowered by the third bus lines 331 and 332 near the sustain and scan electrodes 31 and 32.

As such, the thin layer portions 221 are grooves having dimensions of the width W221, a depth of the first thickness T121 less the second thickness T221, and a length about equal to the length of the PDP in the direction of the x-axis. However, the thin layer portions are not limited to the above description such that the depth of the thin layer portions 221 may increase such that the second thickness 221 is decreased to a maximum extent. In such case, the third bus lines 331 and 332 of the sustain and scan electrodes 31 and 32 may be exposed or only covered with the protective layer 23. Further, the thin layer portions 221 are not limited to corresponding to the third bus lines 331 and 332 of the sustain and scan electrodes 31 and 32 or limited to only two thin layer portions 221 per discharge cell 17. For example, there may be provided a plurality of thin layer portions 221 such that one of the plurality of thin layer portions 221 corresponds to each of a plurality of bus lines provided in the sustain and scan electrodes 31 and 32.

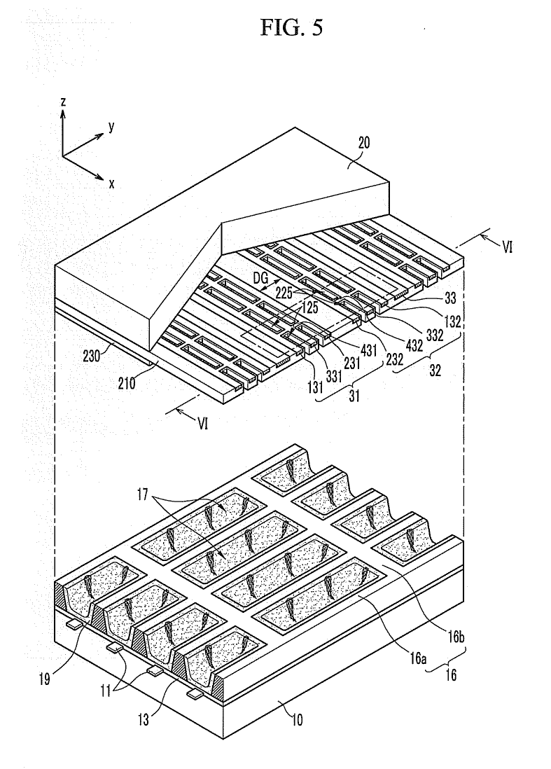

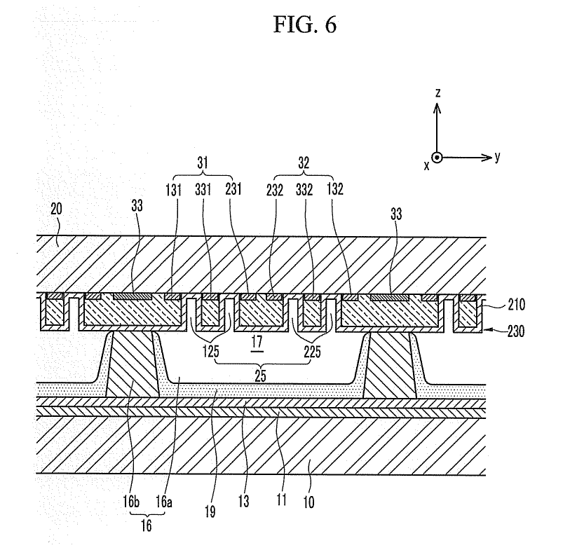

The following will describe a plasma display panel according to aspects of the present invention with reference to FIGS. 5 through 8. Some structures and operation of this second embodiment are identical or similar to those previously described. Therefore, a description of identical portions will be omitted herein.

The second dielectric layer 210 is provided with grooves 25 that are adjacent to and formed according to the arrangement of the first, second, and third bus lines 131, 231, and 331 of the sustain electrodes 31 and the first, second, and third bus lines 132, 232, and 332 of the scan electrodes 32. The protective layer 23 is formed on inner surfaces of the grooves 25 to protect the second dielectric layer 21 provided with the grooves 25 and the front substrate 20 from the discharge.

The grooves 25 include first grooves 125 formed near the sustain electrodes 31 and second grooves 225 formed near the scan electrodes 32. The first grooves 125 increase a light transmittance near the sustain electrodes 31, thereby compensating for the luminance that is lowered by the blocking of the light by the sustain electrodes 31. The second grooves 225 increase a light transmittance near the scan electrodes 32, thereby compensating for the luminance that is lowered by the blocking of the light by the scan electrodes 32.

In more detail, the first grooves 125 near the sustain electrodes 31 are formed between the first and third bus lines 131 and 331 and between the second and third bus lines 231 and 331, respectively. The first grooves 125 are formed with one of the third bus lines 311 disposed therebetween. The first grooves 125 allow the visible light generated from the discharge cell 17 to be emitted through the front substrate 20, thereby increasing the transmittance of the visible light near the sustain electrodes 31. Therefore, the visible light blocked by the third bus lines 331 at one side of the discharge cells 17 is compensated for, and thus the luminance of the PDP is enhanced.

The second grooves 225 near the scan electrodes 32 are formed between the first and third bus lines 132 and 332 and between the second and third bus lines 232 and 332, respectively. The second grooves 225 are formed with the one of the third bus lines 312 disposed therebetween. The second grooves 225 allow the visible light generated from the discharge cells 17 to be emitted through the front substrate 20, thereby increasing the transmittance of the visible light near the scan electrodes 32. Therefore, the visible light blocked by the third bus line 332 at one side of the discharge cells 17 is compensated for, and thus the luminance of the PDP is enhanced.

However, the grooves 25 are not limited to the above description of the first and second grooves 125 and 225. The grooves 25 may also include additional grooves disposed between the sustain and scan electrodes 31 and 32 to correspond with the discharge gap DG formed therebetween so as to further increase the transmission of visible light generated in the discharge cells 17.

Further, the first and second grooves 125 and 225 formed on the dielectric layer 21 increase an amount of wall charges that are generated and accumulated near the sustain and scan electrodes 31 and 32 during the discharge, thereby enhancing an intensity of the visible light.

In order to maximize the compensation of the visible light blocked by the third bus lines 331 and 332 of the respective sustain and scan electrodes 31 and 32, the dielectric layer 21 may be completely removed at a portion corresponding to the third bus lines 331 and 332, thereby incorporating the thin layer portions 221 of the second dielectric layer 21 as described above with respect to FIGS. 1 through 4. However, when the dielectric layer 21 is completely removed at the portion facing the third bus lines 331 and 332, the third bus lines 331 and 332 may not be protected from the discharge. Therefore, the second dielectric layer 210 may be formed to be thinner in an area corresponding to the third bus lines 331 and 332 as compared with the other portions of the second dielectric layer 210.

In FIGS. 5 through 8, the thickness of the second dielectric layer 210 is consistent through all portions of the second dielectric layer 210, but the second dielectric layer 210 is not limited thereto. As described above, the second dielectric layer 210 (of FIGS. 5 through 8) may be similar to the second dielectric layer 21 (of FIGS. 1 through 4), which covers the first, second, and third bus lines 131, 231 and 331 of the sustain electrodes 31 and the first, second and third bus lines 132, 232 and 332 of the scan electrodes 32.

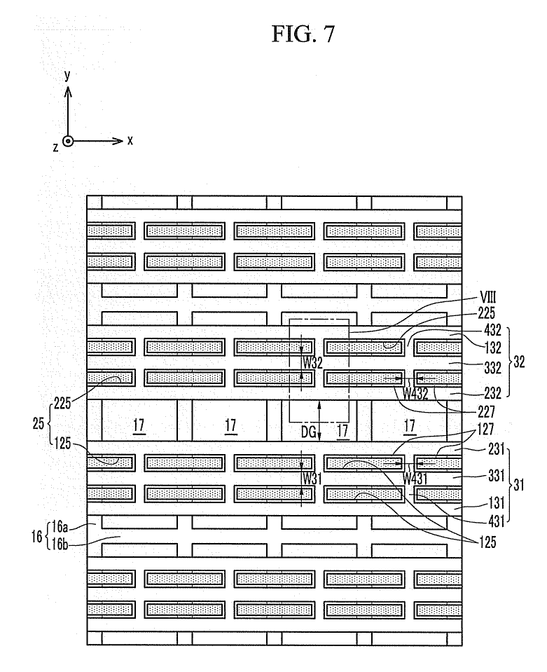

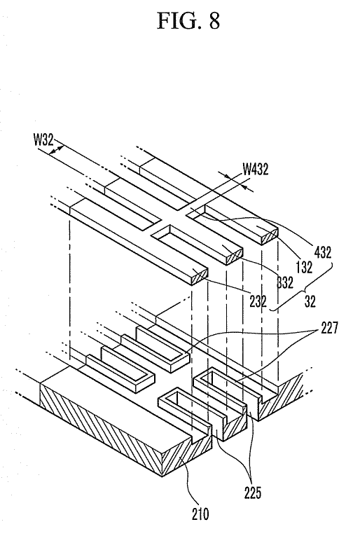

Accordingly, the second dielectric layer 210 includes first frames 127 surrounding side surfaces of the first, second, and third bus lines 131, 231 and 331 and the short bar 431 as illustrated in FIG. 7. The first frame 127 surrounds the first grooves 125. In addition, the second dielectric layer 21 includes second frames 227 surrounding the side surfaces of the first, second, and third bus lines 132, 232, and 332 and the short bar 432. The second frame 227 surrounds the second grooves 225. Even when the dielectric layer 21 is provided with the first and second grooves 125 and 225, the first and second frames 127 and 227 protect the sustain and scan electrodes 31 and 32 from the discharge. As illustrated in FIG. 8, the second dielectric layer 210 comprising the first frames 127 and the second frames 227 does not cover the inner surface of the front substrate 20. However, the second dielectric layer 210 is not limited thereto such that the second dielectric layer 210 may not include the first frames 127 and the second frames 227 and completely cover the exposed inner surfaces of the front substrate 20 and the exposed surfaces of the sustain and scan electrodes 31 and 32.

Although FIGS. 1 through 8 illustrate the thin layer portions 221 and the first and second grooves 125 and 225 having vertical walls with respect to the rear substrate 10 and the front substrate 20, the thin layer portions 221 and the first and second grooves 125 and 225 are not limited thereto. For example, the thin layer portions 221 and the first and second grooves 125 and 225 may be formed such that the walls are disposed at an angle. For example, the width W221 corresponding to the thin layer portion 221, as illustrated in FIG. 4, may be greater nearer the volume of the discharge cells 17 than nearer the third bus lines 332 of the scan electrodes 32 so that the width W221 decreases in the direction from the rear substrate 10 to the front substrate 20. Further, the first and second grooves may be similarly formed.

As described above, in the plasma display panel according to aspects of the present invention, the grooves formed in the dielectric layer, adjacent to the bus lines, located at central portions of the sustain and scan lines increases the light emission uniformity of the discharge cells despite the increase of light emission blocking due to the increase in surface area of the sustain and scan electrodes.

As the grooves are formed in the dielectric layer adjacent to the bus lines located at central portions of the sustain and scan lines, the light transmittance increases in the grooves between the bus lines. Furthermore, since the electric field applied to the grooves of the dielectric layer covering the bus lines is increased, the intensity of the light can be enhanced.

The bus lines at the central portions of the sustain and scan electrodes block a large amount of the visible light emitted from the discharge cells. However, since the grooves formed in the dielectric layer increase the transmittance and intensity of the visible light, the light emission uniformity of the discharge cells is improved. Further, since the thin layer portions are formed on the dielectric layer, the transmittance and intensity of the visible light at both sides of the bus line can be enhanced and the light emission uniformity can be improved.

In the plasma display panel according to aspects of the present invention, the sustain and scan electrodes are formed with the nontransparent bus lines and the portions of the dielectric layer corresponding to the bus lines are formed to be thinner. Therefore, the light emission uniformity of the discharge cells can be improved. Since the thin layer portions are formed in the dielectric layer to correspond to the bus lines at central portions of the sustain and scan lines, the capacitance between the sustain and scan electrodes increases, and thus the wall charges increase during the discharge. In addition, the intensity of the light can be enhanced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel, comprising:
first and second substrates facing each other and spaced apart from each other;
barrier ribs disposed between the first and second substrates to define discharge cells;
phosphor layers formed in the discharge cells;
address electrodes arranged on the first substrate to extend in a first direction;
first and second electrodes formed on the second substrate to extend in a second direction to cross the first direction; and
a dielectric layer disposed on the first and second electrodes and the second substrate,
wherein each of the first and second electrodes comprises at least one bus line formed of a nontransparent material to extend in the second direction on the second substrate, and the dielectric layer is provided with at least one groove formed adjacent to the at least one bus line of each of the first and second electrodes.

2. The plasma display panel of claim 1, wherein the at least one bus line of each of the first and second electrodes comprises at least three bus lines spaced apart from each adjacent bus line of the at least three bus lines in the first direction.

3. The plasma display panel of claim 2, wherein the grooves are formed at both sides of one of the bus lines, the one of the bus lines located centrally within each of the first and second electrodes.

4. The plasma display panel of claim 3, wherein grooves extend in the second direction.

5. The plasma display panel of claim 1, wherein the at least one bus line of the first electrodes include a first bus line arranged at one end portion of the discharge cell and a second bus line arranged parallel to the first bus line, and the second electrodes include a first bus line arranged at another end portion of the discharge cell and a second bus line arranged parallel to the first bus line, the second bus lines of the first and second electrodes being spaced apart from the first bus lines of the first and second electrodes in the first direction toward a central portion of each discharge cell.

6. The plasma display panel of claim 5, wherein the at least one bus line of each of the first and second electrodes further includes at least one third bus line disposed between the first and second bus lines, the first, second, and third bus lines being spaced apart from each other in the first direction.

7. The plasma display panel of claim 6, wherein each of the first and second electrodes includes short bars centrally disposed with respect to the discharge cells and the second direction to connect the first, second, and at least one third bus lines of individual first and second electrodes in the first direction, respectively.

8. The plasma display panel of claim 7, wherein the short bars have widths in the second direction, the width of the short bars being less than a width of each of the first, second, and third bus lines.

9. The plasma display panel of claim 6, wherein the grooves are formed between the at least one third bus line and the first bus line and between the at least one third bus line and the second bus line for each of the first and second electrodes.

10. The plasma display panel of claim 6, wherein the at least one third bus line of each of the first and second electrodes comprises a plurality of third bus lines, and the grooves are formed between adjacent third bus lines.

11. The plasma display panel of claim 6, wherein the barrier ribs include first barrier members extending in the first direction and second barrier members extending in the second direction, and conductive black stripes are formed on an inner surface of the front substrate to correspond in location to the second barrier members.

12. The plasma display panel of claim 1, wherein the at least one bus line is formed of a material including at least one of silver (Ag), platinum (Pt), palladium (Pd), Nickel (Ni), and copper (Cu).

13. A plasma display panel, comprising:
first and second substrates facing each other and spaced apart from each other;
barrier ribs disposed between the first and second substrates to define discharge cells;
phosphor layers formed in the discharge cells;
address electrodes arranged on the first substrate to extend in a first direction;
first and second electrodes formed on the second substrate to extend in a second direction crossing the first direction; and
a dielectric layer disposed on the first and second electrodes and the second substrate, the dielectric layer having a first thickness,
wherein each of the first and second electrodes comprises at least one bus line formed of a nontransparent material on the second substrate and formed to extend in the second direction; and
the dielectric layer has a thick layer portion having the first thickness and a thin layer portion having a second thickness which is less than the first thickness, the thin layer portion being formed to correspond to the bus line.

14. The plasma display panel of claim 13, wherein the thin layer portion is formed at a location corresponding to one of the at least one bus lines of each of the first and second electrodes, the one of the at least one bus lines being centrally located within each of the first and second electrodes.

15. The plasma display panel of claim 14, wherein the thin layer portion extends in the second direction.

16. The plasma display panel of claim 15, wherein the thin layer portion has a width defined in the first direction and the bus line has a width defined in the first direction, wherein the width of the thin layer portion is greater than the width of the bus line.

17. The plasma display panel of claim 6, wherein the grooves are formed so as to expose the at least one third bus line of the first and second electrodes.

18. The plasma display panel of claim 17, further comprising a protective layer disposed to cover the dielectric layer and the exposed third bus lines.

19. The plasma display panel of claim 9, wherein the grooves are formed to expose the second substrate.

20. The plasma display panel of claim 19, further comprising a protective layer disposed to cover the dielectric layer and the exposed second substrate.
